(19) United States
(12) Patent Application Publication
(10) Pub. No.: US 2009/0138811 A1
(43) Pub. Date: May 28, 2009

(54) DISPLAY OBJECT PENETRATING APPARATUS

(76) Inventors: Masaki Horiuchi, Osaka (JP); Mitsuhiro Aso, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/063,210

(22) PCT Filed: Jun. 30, 2006
(86) PCT No.: PCT/JP2006/313136

§ 371 Date: Feb. 7, 2008

(30) Foreign Application Priority Data
Nov. 2, 2005 (JP) 2005-319045

(51) Int. Cl. G06F 3/00

(52) U.S. Cl. 715/768

(57) ABSTRACT

A display object blending apparatus capable of preventing a desired display object from being covered and hidden, by semi-transparently displaying a display object to cover another display object which meets a condition is provided. An instruction section (101), an overlap determination section (102), a condition determination section (103), and a blending section (104) are included. When a new display object is displayed, the overlap determination section (102) determines whether or not the new display object covers an existing display object, the condition determination section (103) determines the transparency of an area including at least an area which covers the existing display object, and the blending section (104) generates display data with the determined transparency. Thus, in accordance with whether or not the existing display object to be covered meets a predetermined condition, it is possible to determine whether or not the new display object is to be made semi-transparent.

### TECHNICAL FIELD

The present invention relates to multi-window display control for displaying a plurality of windows concurrently on one screen, and particularly to, when windows overlap one another, blending of the windows.

### BACKGROUND ART

Conventionally, in an information processing apparatus such as a digital consumer electronics device including a personal computer, a workstation, a mobile phone, and the like, when a plurality of display contents are to be displayed concurrently on one screen, a plurality of rectangular areas referred to as “windows” are displayed by occasionally overlapping one another on a display device typified by that of CRT and that of liquid crystal.

In the above-described multi-window display, however, when an already displayed window is overlapped by a new window, all or a portion of the already displayed window is covered and hidden by the new window.

In a conventional information processing apparatus, in order to display an area hidden by a front window, the hidden area and the front window are mixedly displayed by making the front window semi-transparent in accordance with an instruction received through a key, a mouse, or the like (see Patent Document 1, for example).

FIG. 11 shows an example of display performed by the conventional information processing apparatus. Two non-transparent windows 201 and 202 are displayed in such a manner that a portion of the window 201 covers and hides a portion of the window 202.

In the conventional information processing apparatus, when an instruction is received from a user through a keyboard or a mouse, FIG. 11 enters a display state shown in FIG. 12. In the display state shown in FIG. 12, of the content of the window 202 present behind the window 201 present in the front, the portion covered and hidden by the window 201 in FIG. 11 is displayed by making the overlapping portion of the window 201 semi-transparent (Due to the limitations of the figures, the overlapping portion of the window 201 is shown as transparent, not semi-transparent such that the overlapping portion of the window 202 is completely visible, in FIG. 12).

### Patent Document 1: Japanese Laid-Open Patent Publication No. 10-31573

### DISCLOSURE OF THE INVENTION

### Problems to be Solved by the Invention

In the conventional information processing apparatus, however, the determination of whether or not an already displayed window is to be hidden by a newly displayed window is made in accordance with the user instruction. As a result, there is a problem that important information to be primarily displayed may be difficult to view. The above problem is serious particularly when, for example, in a mobile phone: its screen size is small; a window is likely to hide another window present behind the window; and window display is automatically performed in accordance with an external event such as phone call reception and e-mail reception.

With reference to the drawings, the above problem will be described.

In FIGS. 13, 401, 402, and 403 are windows displayed on a display device such as that of CRT and that of liquid crystal. The window 401 is a pop-up window used in a mobile phone and the like and used at the time of receiving an e-mail. The window 402 is a window used in a television and the like and used to display information of an emergency news bulletin and the like. The window 403 is a window used to display an image of television and the like and is in a state where character information such as a caption is displayed at the bottom of the window. 404 and 405 area diagram showing a screen of the mobile phone.

As described above, in a mobile phone, a window to be displayed may automatically appear regardless of the user operation. In this case, however, in the conventional information processing apparatus, the window cannot manually be made semi-transparent in accordance with the user instruction, and thus there is no choice but to uniformly determine whether a newly created window is to be displayed remaining non-transparent or to be displayed semi-transparently.

The screen 404 of the mobile phone shows an example where all of the windows to be displayed are automatically made non-transparent. 404 shows, in the mobile phone, a screen in which a pop-up display, such as the window 401, of e-mail reception appears while a television image such as the window 403 is being viewed. If displayed non-transparently, the window 401 covers and hides most of an image portion of the window 403 which has been displayed until then.

In contrast, the screen 405 of the mobile phone shows an example where all of the windows to be displayed are automatically made semi-transparent. 405 shows, in the mobile phone, a screen in which a pop-up display, such as the window 402, of a news bulletin appears while the television image such as the window 403 is being viewed. If displayed semi-transparently, the window 402 is mixed with a caption portion of the window 403 which has been displayed until then. As a result, the visibilities of the character information of the window 402 and that of the window 403 are significantly reduced.

The present invention is directed to solving the above conventional problem. An object of the present invention is to provide a display object blending apparatus capable of, when a display object which is a window or a drawn object provided within the window is newly displayed to cover and hide an already displayed display object, determining, based on a predetermined condition, the transparency of the display object which covers and hides and thus determining, in accordance with the type and the state of the display object to be covered and hidden, whether or not the display object which covers and hides is to be made semi-transparent.

### Solution to the Problems

To solve the above conventional problem, a first aspect of the present invention is directed to a display object blending apparatus. The present invention is a display object blending apparatus for performing display control of a display object which is a window and an object to be displayed in the window, the apparatus including: an instruction section for giving an instruction to display a new display object; an overlap determination section for, when one or more display objects are displayed, receiving from the instruction section the instruction to display the new display object and for determining whether or not the new display object and an already displayed display object overlap each other; a condition determination section for determining, as a result of the overlap determination section having determined that the already displayed display object overlaps the new display object, whether or not the already displayed display object meets a predetermined condition and for determining, based on the determination result, a transparency of an area including at least an area which is included in the new display object and which covers the already displayed display object; and a blending section for displaying, with the transparency determined by the condition determination section, a display object to be displayed.

Based on the above features, in accordance with whether or not the display object to be covered and hidden meets the predetermined condition, it is possible to determine whether or not the display object which covers and hides is to be made semi-transparent.

A second aspect of the present invention is directed to a display object blending method for performing display control of a display object which is a window and an object to be displayed in the window. The present invention includes: an instructing step of giving an instruction to display a new display object; an overlap determining step of, when one or more display objects are displayed, receiving from the instruction section the instruction to display the new display object and of determining whether or not the new display object and an already displayed display object overlap each other; a condition determining step of determining, as a result of the overlap determining step having determined that the already displayed display object overlaps the new display object, whether or not the already displayed display object meets a predetermined condition and of determining, based on the determination result, a transparency of an area including at least an area which is included in the new display object and which covers the already displayed display object; and a blending step of displaying, with the transparency determined by the condition determining step, a display object to be displayed.

A third aspect of the present invention is directed to a display object blending program for causing a computer to perform display control of a display object which is a window and an object to be displayed in the window. The present invention causes the computer to execute: an instructing step of giving an instruction to display a new display object; an overlap determining step of, when one or more display objects are displayed, receiving from the instruction section the instruction to display the new display object and of determining whether or not the new display object and an already displayed display object overlap each other; a condition determining step of determining, as a result of the overlap determining step having determined that the already displayed display object overlaps the new display object, whether or not the already displayed display object meets a predetermined condition and of determining, based on the determination result, a transparency of an area including at least an area which is included in the new display object and which covers the already displayed display object; and a blending step of displaying, with the transparency determined by the condition determining step, a display object to be displayed.

### EFFECT OF THE INVENTION

Based on a display object blending apparatus according to the present invention, in accordance with the type and the state of a display object to be covered and hidden, it is possible to flexibly determine whether or not a display object which covers and hides is to be made semi-transparent.

### BRIEF DESCRIPTION OF THE DRAWINGS

FIG. 1 is a block diagram showing an example structure of a display object blending apparatus according to an embodiment of the present invention.

FIG. 2 is a flow chart showing an example of a display method determination and a display operation of the display object blending apparatus according to the embodiment of the present invention.

FIG. 3 is a flow chart showing an example of the display method determination and the display operation of the display object blending apparatus according to the embodiment of the present invention.

FIG. 4 is a diagram showing an example of a screen using the display object blending apparatus according to the embodiment of the present invention.

FIG. 5 is a diagram showing an example of the screen using the display object blending apparatus according to the embodiment of the present invention.

FIG. 6 is a diagram showing an example of the screen using the display object blending apparatus according to the embodiment of the present invention.

FIG. 7 is a flow chart showing an example of the display method determination and the display operation of the display object blending apparatus according to the embodiment of the present invention.

FIG. 8 is a diagram showing an example of the screen using the display object blending apparatus according to the embodiment of the present invention.

FIG. 9 is a flow chart showing an example of the display method determination and the display operation of the display object blending apparatus according to the embodiment of the present invention.

FIG. 10 is a diagram showing an example of the screen using the display object blending apparatus according to the embodiment of the present invention.

FIG. 11 is a diagram showing an example of display performed by a conventional display device.

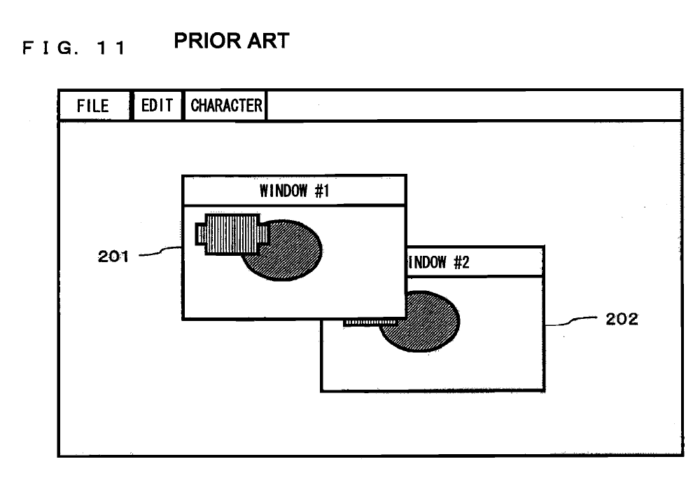

FIG. 12 is a diagram showing an example of the display performed by the conventional display device.

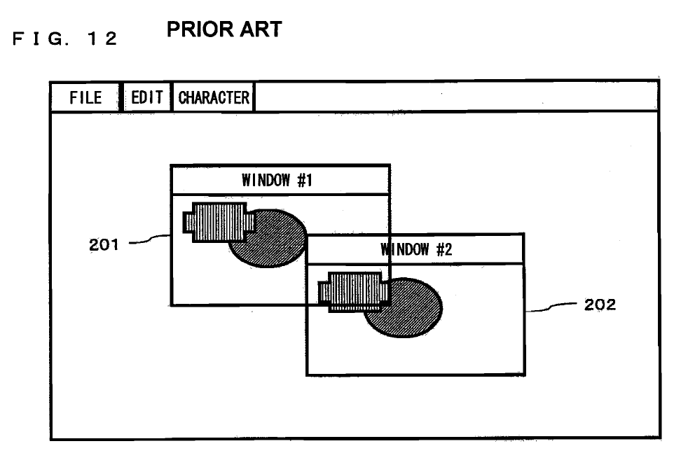

FIG. 13 is a diagram showing an example of display performed by the conventional display device.

### DESCRIPTION OF THE REFERENCE CHARACTERS

101 instruction section
102 overlap determination section
103 condition determination section
104 blending section
105 display section
106 display object storage section
107 frame memory

### BEST MODE FOR CARRYING OUT THE INVENTION

With reference to the drawings, an embodiment of the present invention will be described below.

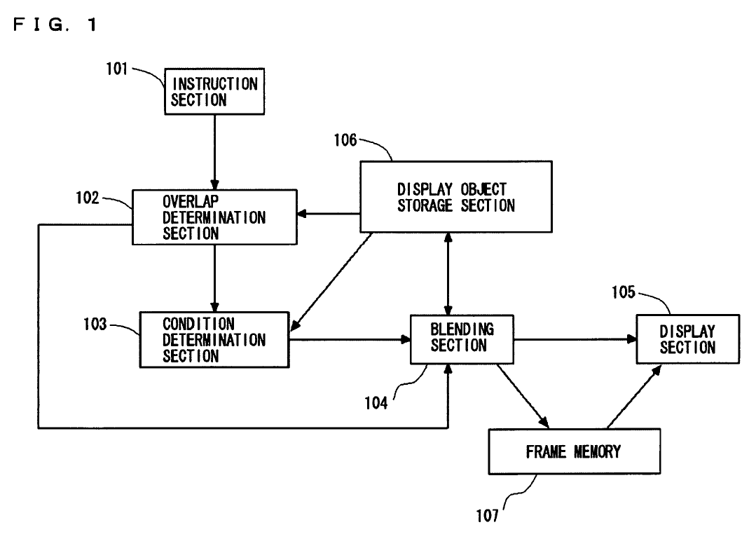

FIG. 1 is a block diagram showing an example structure of a display object blending apparatus according to the embodiment of the present invention.

In FIG. 1, an instruction section 101 receives an input from a user through an input device such as a key, a button and a mouse, an external event such as phone call reception and e-mail reception, a command issued by an arbitrary application used in a device including the display object blending apparatus of the present invention, and the like, and outputs an instruction to display a new display object. For example, when an instruction to start up an application is given, the instruction section 101 outputs an instruction to display, as a display object, an initial screen window of the application to be started up.

A display object storage section 106 has stored therein display object information regarding each display object displayed on a screen. The display object information includes the display position, the size, the transparency, and the like of each display object. Note that as well as the above information, the display object information may include the display object type such as a text and an image, the shape such as a rectangle and a circle, the display priority, and the like of each display object. The display priority will be described in detail below.

An overlap determination section 102 compares the display object information regarding a new display object which is received from the instruction section 101, to the display object information regarding a display object already displayed on the screen, which is stored in the display object storage section 106, and determines the presence or absence of overlap between the new display object and the display object already displayed on the screen. When it is determined that the overlap is present, the overlap determination section 102 provides a condition determination section 103 with a notification. When it is determined that the overlap is not present, the overlap determination section 102 provides a blending section 104 with a notification.

Based on the notification provided by the overlap determination section 102, the condition determination section 103 determines whether or not the display object (a display object A) already displayed on the screen and obtained as a result of the determination that the new display object (a display object B) overlaps the display object already displayed on the screen, meets a predetermined condition. Further, based on the determination result, the transparency of the display object B is determined. Note that with reference to a specific example, the predetermined condition will be described below.

The blending section 104 receives the notification from the overlap determination section 102 or a notification from the condition determination section 103, generates display data of the display object B with the determined transparency, stores the display data into a frame memory 107, and displays the above-described two display objects on a display section 105 which is a display device such as that of CRT or that of liquid crystal. Further, when displaying the display objects on the display section 105, the blending section 104 can control the transparencies of the display objects by determining whether the transparencies are to be fixed, are to be cyclically variable, or the like.

Note that the instruction section 101 gives not only an instruction to newly display a display object on the display section 105. The instruction section 101 can also be applied to the above-described determination of the transparency and the above-described display process when the instruction section 101 gives any instruction to display a display object, regardless of the type of an operation based on which the display object is displayed. The above operation may include: displaying, by hiding an already displayed display object, another display object all or a portion of which has been hidden and appears due to hiding the already displayed display object; displaying a display object by moving the display object from the bottom to the top of a displayed hierarchy of display objects so as to be visible on the screen; displaying a display object which has newly appeared due to a coordinate change (the movement of the display position) thereof; and the like.

Although three main types of basic operations will be described in detail below, these operations may be performed separately or combined.

(Operation 1: Semi-Transparent Display Process of a Display Object)

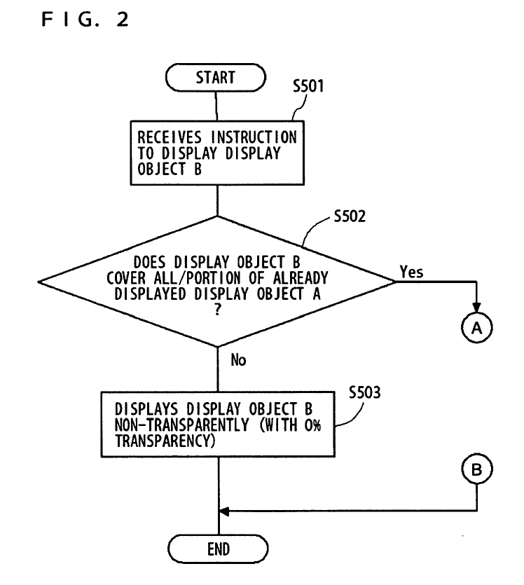

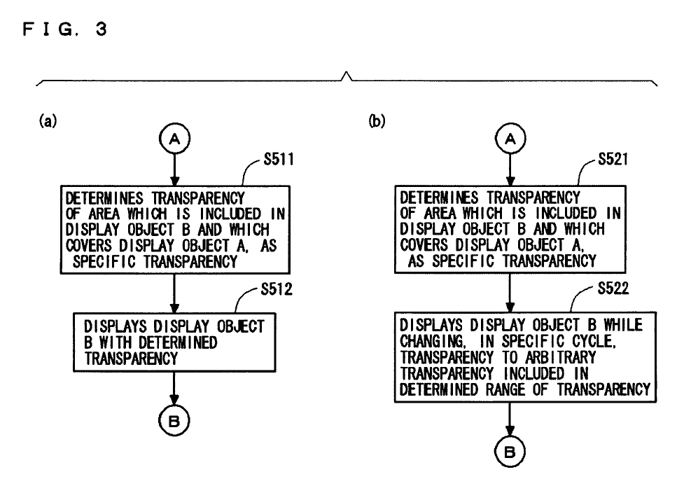

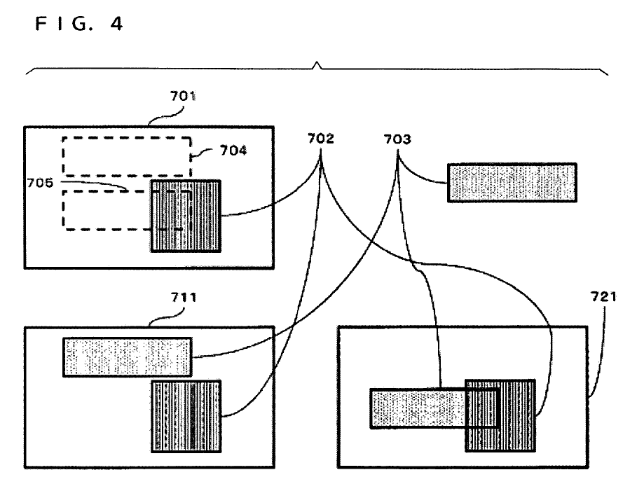

With reference to a flow chart of FIGS. 2 and 3 and a diagram of FIG. 4 which shows a screen of the display section 105, a display method determination and a display operation of the display object blending apparatus according to the present embodiment will be described.

FIG. 4 is a schematic diagram showing the screen of the display section 105.

701 is the screen of the display section 105. 702 is a display object A which is displayed on the screen 701 and which meets a predetermined condition. 703 is a display object B to be newly displayed based on an instruction from the instruction section 502. 704 and 705 are dashed lines representing positions at each of which the display object B 703 is to be displayed on the screen 701.

711 shows a case where the display object B 703 is displayed at the position of the dashed line 704 and does not cover the display object A 702. On the other hand, 721 shows a case where the display object B 703 is displayed at the position of the dashed line 705 and covers a portion of the display object A 702.

Note that the predetermined condition which the display object A 702 meets may be a condition related to a display operation trigger in which, based on a specific event or a specific application, the instruction section 101 has been instructed to perform display.

Further, the predetermined condition which the display object A 702 meets may be a condition related to the shape or the appearance of a display object, such as: whether or not the display object is larger than, equal to, or smaller than a specific size; whether or not the display object is in a specific color; or whether or not the display object induces a specific figure or a specific character.

Note that in FIG. 4, the display object A 702 and the display object B 703 are represented as rectangles, but may be shapes other than rectangular.

With reference to FIGS. 2 and 3, an operation performed for newly displaying a display object will be described. Here, as an example, described in detail is a case where the operation is started from the screen 701 of FIG. 4.

First, in step S501, the instruction section 101 receives an instruction to display the display object B 703 at a specific position (the position of the dashed line 704 or of the dashed line 705) provided in the screen 701.

Next, in step S502, the overlap determination section 102 determines whether or not the display object B 703 covers all or a portion of the display object A 702 already displayed on the screen 701. When displayed at the position of the dashed line 704, the display object B 703 does not cover the display object A 702. When displayed at the position of the dashed line 705, the display object B 703 covers a portion of the display object A 702.

Since the display object B 703 does not cover the display object A 702 (“No” in step S502) when displayed at the position of the dashed line 704, the overlap determination section 102 provides, in step S503, the blending section 104 with a notification, and then the blending section 104 generates, with 0% (completely-non-transparent) transparency, the display data of the display object B, displays the display object B on the display section 105, and ends the process. In FIG. 4, 711 is the screen of the display section 105 and shows a state where the display object B 703 is displayed with 0% transparency.

On the other hand, since the display object B 703 covers a portion of the display object A 702 (“Yes” in step S502) when displayed at the position of the dashed line 705, the overlap determination section 102 provides, in step S511, the condition determination section 103 with a notification, and then the condition determination section 103 determines the transparency of an area which is included in the display object B 703 and which covers the display object A 702. In step S512, the condition determination section 103 provides the blending section 104 with a notification, and then the blending section 104 generates, with a specific transparency obtained based on the notification, the display data of the display object B, displays the display object B on the display section 105, and ends the process. In FIG. 4, 721 is the screen of the display section 105 and shows a state where the display object B 703 is displayed with the specific transparency which is not 0% (not completely non-transparent) (Due to the limitations of the figures, 703 is shown as transparent, not semi-transparent such that the overlapping portion of 702 is completely visible, in FIG. 4).

Note that the screen 721 shows that only the portion which is included in the display object B 703 and which covers the display object A 702 is displayed semi-transparently, but the transparency may be an arbitrary value, and so long as at least the area which is included in the display object B 703 and which covers the display object A 702 is included, a semi-transparent area (e.g., the whole area of 703) may be wider than the area which covers the display object A 702.

Further, since the display object B 703 covers a portion of the display object A 702 when displayed at the position of the dashed line 705, the area which is included in the display object B 703 and which covers the display object A 702 may be displayed while changing, in a specific cycle, the transparency of the area to an arbitrary transparency included in the range of specific transparency, in step S522.

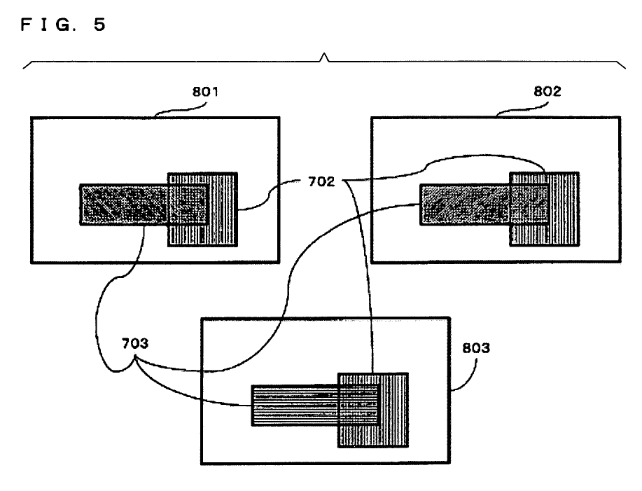

FIG. 5 is a schematic diagram showing the change of the screen of the display section 105 in this case. In FIG. 5, the same elements as those of FIG. 4 will be denoted by the same numerals, and therefore will not be described.

801, 802, and 803 are the screens of the display section 105, and in the screen 801, the display object B 703 is displayed with 25% transparency (Due to the limitations of the figures, an area of 25% transparency is represented by diagonal lines from top left to bottom right). Similarly, in the screens 802 and 803, the display object B 703 is displayed with 50% transparency and 75% transparency, respectively (Due to the limitations of the figures, areas of 50% transparency and 75% transparency are represented by diagonal lines from top right to bottom left and a horizontal-line pattern, respectively).

When the transparency is cyclically changed from 25% to 50% to 75% to 50% to 25%, the screen changes from 801 to 802 to 803 to 802 to 801 with the display object B becoming gradually thicker and thinner. Consequently, even when a display object present in the front and a display object present in the rear are displayed semi-transparently with a fixed transparency and therefore the visibilities thereof are reduced, the display objects may be displayed by alternately and gradually making either one thicker than the other, whereby it is possible to improve the visibilities of both of the display objects.

Note that in FIG. 5, as an example, the transparency is represented as 25%, 50%, and 75%, but is neither limited to the range of 25% to 75% nor limited to any of the values of 25, 50, and 75, and may be changed to another arbitrary value in the range of specific transparency.

Further, in the above description, as an example, the transparency is gradually increased, is then gradually decreased, and returns to the original value. However, the cyclical change of the value of the transparency is not limited thereto.

The above-described change of the transparency is effective in semi-transparently displaying particularly a display object including characters, and an example thereof will be described below.

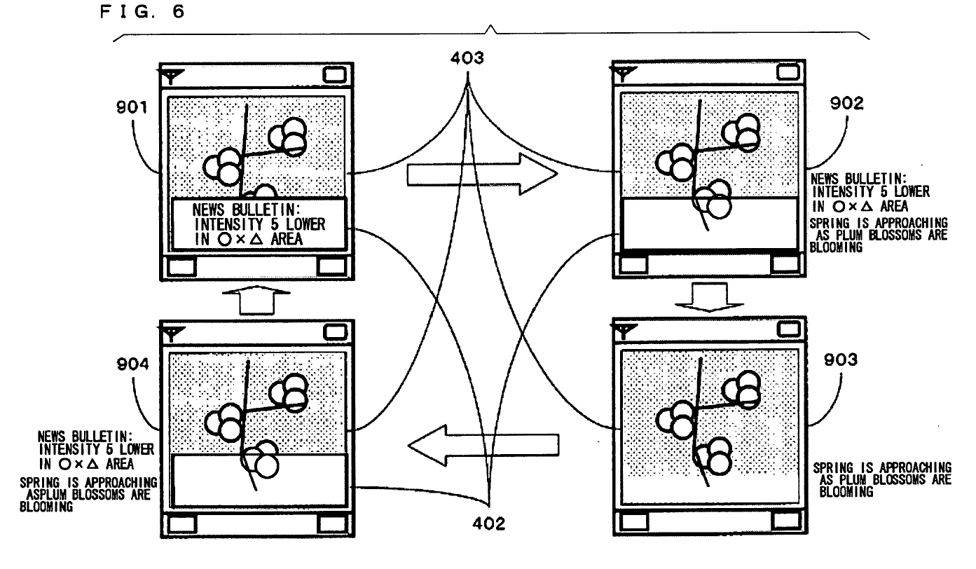

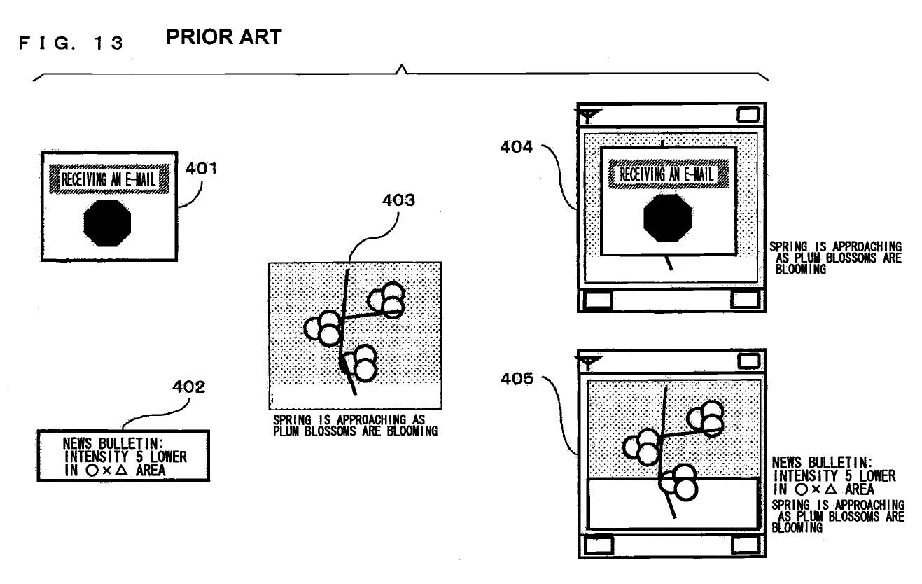

FIG. 6 is a schematic diagram showing the screen of the display section 105, to which the above-described change of the transparency is applied when a display object including characters covers another display object including characters. In FIG. 6, the same elements as those of FIG. 13 will be denoted by the same numerals, and therefore will not be described.

901, 902, 903, and 904 are the screens of the display section 105 and show a state where the window 402 including characters is displayed to cover the window 403 including characters.

It is described in the PROBLEMS TO BE SOLVED BY THE INVENTION (see the screen 405 of FIG. 13) that in this case, when the window 402 is displayed with the transparency having a fixed value, the visibilities of the windows 402 and 403 are so reduced that the characters of both of the windows 402 and 403 cannot be recognized.

The window 402 as a news bulletin pop-up window is displayed completely non-transparently with 0% transparency in the screen 901, and the transparency is gradually increased from 0% in this state to 50% in the screen 902 to 100% in the screen 903.

Thus, the characters of the window 402 gradually become invisible while the characters of the window 403 gradually become visible, and consequently, the characters of the window 403 are completely visible in the screen 903.

When the transparency of the window 402 is subsequently decreased from 100% in this state to 50% in the screen 904 again and then returns to 0% in the screen 901 again, the characters of the window 402 become visible again (Due to the limitations of the figures, the frame and the characters of the window 402 are represented in black and the window 403 present in the rear is visible through the other area of the window 402, in the screens 902 and 904 of FIG. 6. However, since the transparency of the window 402 is 50% as described above, the whole area of the window 402 is, in fact, semi-transparent).

As described above, when the transparency of the window 402 is cyclically changed from 100% to 50% to 0% to 50% to 100%, the screen changes from 901 to 902 to 903 to 904 to 901. Consequently, the windows 402 and 403 may be displayed by alternately and gradually making either one thicker than the other, whereby it is possible to improve the visibilities of both of the windows 402 and 403.

Thus, in accordance with whether or not a display object to be covered and hidden meets a predetermined condition, it is possible to determine whether or not the display object which covers and hides is to be made semi-transparent.

Further, the transparency of a newly displayed display object may be cyclically changed, whereby it is possible to cyclically and alternately display both of an already displayed display object and the newly displayed display object.

(Operation 2: Process Performed for Displaying a Display Object which Covers a Semi-Transparently Displayed Display Object)

In the present embodiment, the determination of the transparency of a display object which covers a display object of which the transparency is 0%, is described. However, when a display object covers a display object already displayed with a specific transparency (a value other than 0%) or already displayed while changing, in a specific cycle, the transparency thereof to an arbitrary transparency, the transparency of the display object to be covered may be changed to 0%. Thus, it is possible to prevent a plurality of display objects displayed semi-transparently from overlapping each other and therefore is possible to prevent the visibilities thereof from being reduced.

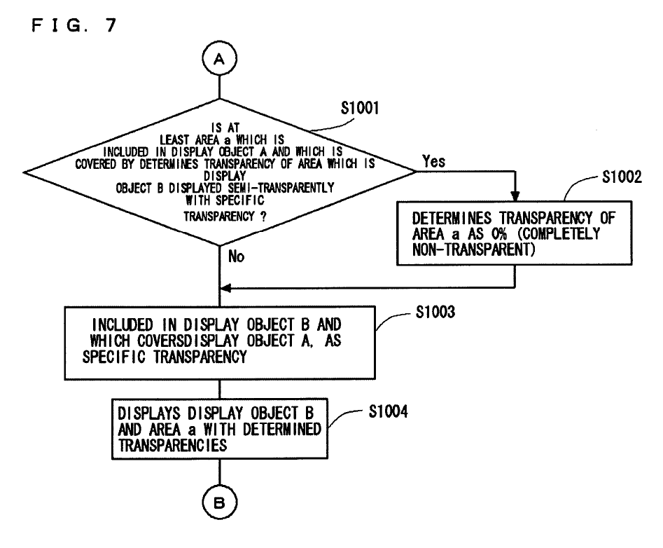

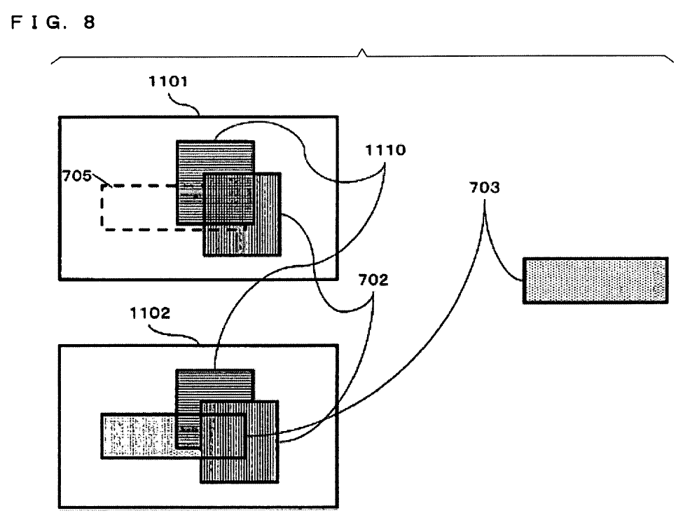

With reference to a flow chart of FIGS. 2 and 7 and a diagram of FIG. 8 which shows the screen of the display section 105, a process of changing the transparency of a display object to be covered to 0% will be described.

FIG. 8 is a schematic diagram showing the screen of the display section 105. In FIG. 8, the same elements as those of FIG. 4 will be denoted by the same numerals, and therefore will not be described.

1101 is the screen of the display section 105. 1110 is a display object C, a portion of which is covered by the display object A 702 described in FIG. 4. Further, the display object A 702 is displayed with 50% transparency, based on the above-described transparency determination process of a display object (Due to the limitations of the figures, an area which is included in 702 and which covers 1110 is represented by a grid pattern and the other area of 702 is represented by a vertical-line pattern, in FIG. 8. However, since the transparency of the whole area of 702 is 50%, the whole area of 702 is, in fact, semi-transparent).

A process for displaying the display object B 703 at the position of the dashed line 705 is first started from the screen 1101. The process of and prior to step S502 in the flow chart of FIG. 2 is already described, and therefore will not be described.

The process performed in the case of “Yes” in step S502, that is, the process performed after step S502 when the display object B 703 covers the display object A 702, will be described with reference to the flow chart of FIG. 7.

In step S1001, the overlap determination section 102 provides the condition determination section 103 with a notification, and then the condition determination section 103 determines whether or not at least an area a (an area which is included in the display object A 702 and which overlaps an area surrounded by the dashed line 705 in the screen 1101 of FIG. 8) which is included in the display object A and which is covered by the display object B is displayed semi-transparently with a specific transparency.

When the area a is displayed completely non-transparently (“No” in step S1001), the condition determination section 103 determines, in step S1003, the transparency of an area which is included in the display object B 703 and which covers the display object A 702. In step S1004, the condition determination section 103 provides the blending section 104 with a notification, and then the blending section 104 generates, with a specific transparency obtained based on the notification, the display data of the display object B, displays the display object B on the display section 105, and ends the process.

On the other hand, when the area a is displayed semi-transparently (the transparency other than 0%) with a specific transparency (“Yes” in step S1001), the condition determination section 103 determines, in step S1002, the transparency of the area a as 0% (completely non-transparent), and then proceeds to step S1003. The condition determination section 103 determines the transparency of an area which is included in the display object B 703 and which covers the display object A 702. In step S1004, the condition determination section 103 provides the blending section 104 with a notification, and then the blending section 104 generates, with a specific transparency obtained based on the notification, the display data of the display object B, displays the display object B on the display section 105, and ends the process.

1102 shows the screen in which the above step S1002 is performed. In the screen 1101, the pattern of even a portion which is included in the display object C 1110 and which is covered by the display object A 702 is displayed transparently therethrough. However, in the screen 1102, as a result of changing the transparency of the area a to 0%, the covered portion becomes invisible (Due to the limitations of the figures, the vertical-line pattern of 702 and a horizontal-line pattern of 1110 are displayed unchanged in portions where 703 covers 702 and 1110, in FIG. 8. However, since the transparency of the whole area of 703 is 50%, both the portions where 703 covers 702 and 1110 are, in fact, semi-transparent).

Note that in FIG. 8, the transparencies of the whole areas of the display object A 702 and the display object B 703 are both 50%, but may be different transparencies, and not the whole areas of the display objects A and B but at least an area which is included in the display object B and which covers the display object A or an area which is included in the display object A and which covers the display object C may be included.

Further, in FIG. 8, the transparencies of the display object A 702 and the display object B 703 are each 50% as a fixed value. However, each of the display object A 702 and the display object B 703 may be displayed while changing, in a specific cycle, the transparency thereof to an arbitrary transparency included in the range of specific transparency.

Similarly, the determination condition of step S1001 in the flow chart of FIG. 7 is not limited to the area a, and at least an area which is included in the display object A and which covers the display object C may be included.

Similarly, the determination condition of step S1001 in the flow chart of FIG. 7 is whether or not the area a is displayed semi-transparently with a specific transparency. However, the specific transparency may not be a fixed transparency and the determination may be made based on whether or not the area a is displayed while changing, in a specific cycle, the transparency thereof to an arbitrary transparency included in the range of specific transparency.

Thus, in a case where a display object is newly displayed to cover a display object already displayed semi-transparently or already displayed while cyclically changing the transparency thereof, it is possible to prevent the visibilities of the display objects from being reduced when the newly displayed display object is made semi-transparent.

(Operation 3: Process Performed when Display Objects have Display Priorities)

In the above-described operation 1 and operation 2 of the present embodiment, when a display object is displayed, the determination of whether or not the display object is to be made semi-transparent is made in accordance with whether or not an already displayed display object meets a predetermined condition. However, each display object may be provided with a display priority and the determination may be made in accordance with the result of comparison between the display priorities, whereby a display object may become semi-transparent only when covering an important display object.

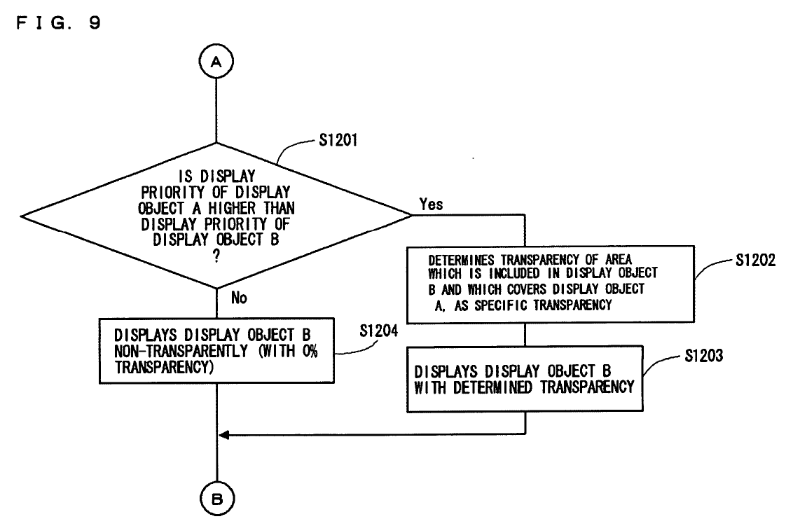

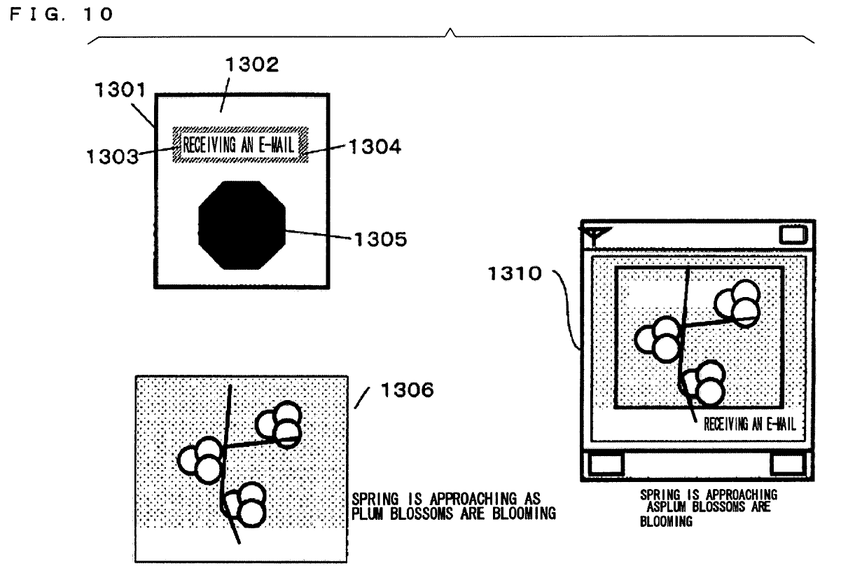

With reference to a flow chart of FIGS. 2 and 9 and a diagram of FIG. 10 which shows the screen of the display section 105, a process performed when display objects have display priorities will be described.

Each element of FIG. 4 is already described above, and therefore will not be described.

A process for displaying the display object B 703 at the position of the dashed line 705 is first started from the screen 701. The process of and prior to step S502 in the flow chart of FIG. 2 will only be described insofar as it differs from the above.

In step S501, the instruction section 101 gives an instruction to display the display object B, and in the present operation, gives an instruction to display the display object B by specifying the display priority therefor.

The display priority is a priority which is set for a display object and which is used to display the display object on the display section 105, and in the present operation, is used to determine whether or not the display object is to be made semi-transparent.

Note that the display priority is set based on the specification made by the instruction section 101, and the display priority of a display object already displayed on the display section 105 is retained in the display object blending apparatus.

The process performed in the case of “Yes” in step S502, that is, the process performed after step S502 when the display object B 703 covers the display object A 702, will be described with reference to the flow chart of FIG. 9.

In step S1201, the overlap determination section 102 provides the condition determination section 103 with a notification, and then the condition determination section 103 determines, by comparing the display priorities of the display object A 702 and the display object B 703 to each other, whether or not the display priority of the display object A 702 is higher.

When the determination result of step S1201 is “Yes” (i.e., when the display priority of the display object A is higher), the condition determination section 103 determines, in step S1202, the transparency of an area which is included in the display object B 703 and which covers the display object A 702. In step S1203, the condition determination section 103 provides the blending section 104 with a notification, and then the blending section 104 generates, with a specific transparency obtained based on the notification, the display data of the display object B, displays the display object B on the display section 105, and ends the process. As shown in the screen 721 of FIG. 4, the area which is included in the display object B 703 and which covers the display object A 702 is displayed semi-transparently with the specific transparency.

On the other hand, when the determination result of step S1201 is “No” (i.e., when the display priority of the display object B is higher), in step S1204, the condition determination section 103 generates, with 0% (completely-non-transparent) transparency, the display data of the display object B, displays the display object B on the display section 105, and ends the process.

Note that in the present embodiment, the determination is made by comparing the display priorities which are set for display objects, and when the display priority of the display object to be covered is higher, it is determined that the display object which covers is to be made semi-transparent. However, the present invention is not limited thereto. The determination method is not particularly specified so long as the transparency is determined based on the result of comparison between the display priorities. For example, the degree of transparency may be changed depending on the size of the difference between the display priorities.

Note that in the screen 721 of FIG. 4, the whole area of the display object B 703 is displayed semi-transparently with 50% transparency, but may be displayed with a different transparency, and at least an area which is included in the display object B 703 and which covers the display object A 702 may be included.

Further, in the screen 721 of FIG. 4, the display object B 703 may be displayed while changing, in a specific cycle, the transparency thereof to an arbitrary transparency included in the range of specific transparency.

Similarly, although in FIG. 9, the flow chart shows that step S1203 is to be performed, S522 of FIG. 3 (b) may be performed in lieu of step S1203.

Further, the display priority may not necessarily have a unique value in the whole area of a display object. When the display object is a window, the display priorities may be set separately for a border and a non-border area of the window. When the display object is an object to be displayed within the window, the display priorities may be set separately for a foreground section and a background section of the object. Thus, it is possible to perform display control based on more detailed display priorities.

With reference to FIG. 10, an example of an effect obtained when the display priorities of display objects are set in detail will be described.

FIG. 10 is a diagram showing a case where the display priorities of the windows 401 and 403 of FIG. 13 are set in detail. 1301 through 1305 are elements of the window 401 of FIG. 13, to which elements the display priorities are assigned individually.

1301 is a border of the window 401. 1302 is a non-border area of the window 401. 1303 and 1304 are a foreground section and a background section, respectively, of the characters provided within the window 401. 1305 is a foreground section of a figure (an octagon) provided within the window 401. A background section of the octagon provided within the window 401 is not present such that the non-border area provided within the window 401 can be viewed unchanged behind the octagon.

1306 is a non-border area of the window 403.

When the display priorities are set as P1>P2>P3, the premise is that: the display priorities of the border 1301 and the foreground section 1303 of the window 401 are P1; the display priority of the non-border area 1306 of the window 403 is P2; and the display priorities of the non-border area 1302, the background section 1304 of the characters, and the octagonal FIG. 1305, which are provided within the window 401 are P3.

In this case, 1310 is a screen of a display device 501 in which the window 401 is displayed to cover the non-border area 1306 of the window 403 in a case where a display object blending section 503 displays, with 0% transparency, a display object having a higher display priority to cover a display object having a lower display priority and displays, with 100% transparency, a display object having a lower display priority to cover a display object having a higher display priority.

Since the display priority of the non-border area 1306 of the window 403 is P2, only the elements of the display object 401 of which the display priorities are P1 that is higher than P2, are displayed with 0% transparency and the other elements are displayed with 100% transparency and invisible.

As a result, only minimum necessary characters of a pop-up window used at the time of receiving an e-mail may be displayed while a television screen is being viewed, whereby it is possible to reduce an area which covers the television screen.

Thus, based on the result of comparison between the display priorities of a newly displayed display object and a display object to be covered, it is possible to determine whether or not the newly displayed display object is to be made semi-transparent.

Further, it is possible to assign the display priorities individually to a border and a non-border portion of a window, a foreground area and a background area of a drawn object provided within the window, and the like, and is possible to specify, in more detail, areas to be made semi-transparent.

Further, when the display priorities of an already displayed display object and a newly displayed display object are the same, the transparencies thereof may be cyclically and gradually increased and decreased, whereby it is possible to automatically and alternately display the already displayed display object and the newly displayed display object. Note that in the present embodiment, the overlap determination section 102, the condition determination section 103, and the blending section 104 are represented as separate blocks, but may not necessarily be separate, and may be manufactured as a single chip using an integrated circuit such as an LSI or a dedicated signal processing circuit. Alternatively, equivalents of the functions of these blocks may be separately manufactured as chips. The integrated circuit is referred to herein as an LSI, but may be referred to as an IC, a system LSI, a super LSI, an ultra LSI, etc., depending on the degree of integration. Further, the method of integration is not limited to LSI, and may be realized by a dedicated circuit or a general-purpose processor. An FPGA (Field Programmable Gate Array), which is an LSI that can be programmed after manufacture, or a reconfigurable processor capable of reconfiguring the connections and the settings of the circuit cells in the LSI may also be used. Furthermore, in a case where another integration technology replacing LSI becomes available due to improvement of a semiconductor technology or due to the emergence of another technology derived therefrom, integration of functional blocks may obviously be performed using such a new integration technology.

### INDUSTRIAL APPLICABILITY

A display object blending apparatus according to the present invention is capable of flexibly determining, in accordance with the type and the state of an already displayed display object, whether or not a display object which covers the already displayed display object is to be made semi-transparent, and of preventing the already displayed display object from being hidden, and therefore is useful for a device and a system such as a mobile phone and a personal digital assistant, in each of which its screen is so small that a display object is likely to hide another display object. Further, the display object blending apparatus can also be applied to a digital camera, an in-car system, and the like.

1. A display object blending apparatus for performing display control of a display object which is a window and an object to be displayed in the window, the apparatus comprising:
an instruction section for giving an instruction to display a new display object;
an overlap determination section for, when one or more display objects are displayed, receiving from the instruction section the instruction to display the new display object and for determining whether or not the new display object and an already displayed display object overlap each other;
a condition determination section for determining, as a result of the overlap determination section having determined that the already displayed display object overlaps the new display object, whether or not the already displayed display object meets a predetermined condition and for determining, based on the determination result, a transparency of an area including at least an area which is included in the new display object and which covers the already displayed display object; and
a blending section for displaying, with the transparency determined by the condition determination section, a display object to be displayed.

2. The display object blending apparatus according to claim 1,
wherein the display object has a display priority,
wherein the instruction section gives the instruction to display the new display object by arbitrarily specifying the display priority for the new display object, and
wherein the condition determination section determines the transparency using the display priority of the new display object and the display priority of the already displayed display object obtained as a result of having determined that the already displayed display object overlaps the new display object.

3. The display object blending apparatus according to claim 1,
wherein the blending section displays the area including at least an area which is included in the new display object and which covers the already displayed display object, while changing, in a specific cycle, the transparency to an arbitrary transparency included in a range of specific transparency.

4. The display object blending apparatus according to claim 2,
wherein, when the display object is the window, a border of the window and a non-border region of the window are associated with the display priorities, separately, and when the display object is the object to be displayed in the window, a foreground section and a background section of the object are associated with the display priorities, separately.

5. The display object blending apparatus according to claim 2,
wherein, when the display priority of the already displayed display object is higher than the display priority of the new display object, the condition determination section determines the transparency of the area including at least an area which is included in the new display object and which covers the already displayed display object, as a completely-transparent transparency.

6. The display object blending apparatus according to claim 2,
wherein, when the display priority of the already displayed display object is lower than the display priority of the new display object, the condition determination section determines the transparency of the area including at least an area which is included in the new display object and which covers the already displayed display object, as a completely-non-transparent transparency.

7. The display object blending apparatus according to claim 2,
wherein, when the display priority of the already displayed display object is the same as the display priority of the new display object,
the blending section displays the area including at least an area which is included in the new display object and which covers the already displayed display object, while in a specific cycle, starting with an arbitrary transparency, gradually increasing the arbitrary transparency, gradually decreasing the arbitrary transparency when the arbitrary transparency reaches a predetermined maximum value, and gradually increasing the arbitrary transparency again when the arbitrary transparency reaches a predetermined minimum value.

8. The display object blending apparatus according to claim 2,
wherein, when the display priority of the already displayed display object is the same as the display priority of the new display object,
the blending section displays the area including at least an area which is included in the new display object and which covers the already displayed display object, while in a specific cycle, starting with an arbitrary transparency, gradually decreasing the arbitrary transparency, gradually increasing the arbitrary transparency when the arbitrary transparency reaches a predetermined minimum value, and gradually decreasing the arbitrary transparency again when the arbitrary transparency reaches a predetermined maximum value.

9. The display object blending apparatus according to claim 1,
wherein, when a transparency area is present as the area including at least an area which is included in the new display object and which covers the already displayed display object, and is also present as an area displayed with a transparency which is not a non-transparent transparency or an area displayed while changing, in a specific cycle, the transparency of the area to an arbitrary transparency included in a range of specific transparency, the condition determination section makes the transparency area completely non-transparent.

10. A display object blending method for performing display control of a display object which is a window and an object to be displayed in the window, the method comprising:
an instructing step of giving an instruction to display a new display object;
an overlap determining step of, when one or more display objects are displayed, receiving from the instruction step the instruction to display the new display object and of determining whether or not the new display object and an already displayed display object overlap each other;
a condition determining step of determining, as a result of the overlap determining step having determined that the already displayed display object overlaps the new display object, whether or not the already displayed display object meets a predetermined condition and of determining, based on the determination result, a transparency of an area including at least an area which is included in the new display object and which covers the already displayed display object; and
a blending step of displaying, with the transparency determined by the condition determining step, a display object to be displayed.

11. A display object blending program for causing a computer to perform display control of a display object which is a window and an object to be displayed in the window,
the program causing the computer to execute:
an instructing step of giving an instruction to display a new display object;
an overlap determining step of, when one or more display objects are displayed, receiving from the instruction step the instruction to display the new display object and of determining whether or not the new display object and an already displayed display object overlap each other;
a condition determining step of determining, as a result of the overlap determining step having determined that the already displayed display object overlaps the new display object, whether or not the already displayed display object meets a predetermined condition and of determining, based on the determination result, a transparency of an area including at least an area which is included in the new display object and which covers the already displayed display object; and
a blending step of displaying, with the transparency determined by the condition determining step, a display object to be displayed.
